(19) United States
(12) Patent Application Publication
(10) Pub. No.: US 2004/0142245 A1
(43) Pub. Date: Jul. 22, 2004

(54) Nonaqueous secondary cell and electronic device incorporating same

(76) Inventors: Takushi Ishikawa, Kohata (JP); Fusaji Kita, Osaka (JP)

Correspondence Address: OSHA & MAY L.L.P., 1221 MCKINNEY STREET, HOUSTON, TX, 77010, US

(21) Appl. No.: 10/481,366

(22) PCT Filed: Jan. 22, 2003
(86) PCT No.: PCT/JP03/00509

(30) Foreign Application Priority Data
Jan. 24, 2002 (JP) 2002-16214

(51) Int. Cl. H01M 2/16; H01M 10/40

(52) U.S. Cl. 429/247; 429/324; 429/332; 429/231.95

(57) ABSTRACT

A non-aqueous secondary battery includes a positive electrode 1, a negative electrode 2, a separator 3, and a non-aqueous electrolyte solution, wherein the non-aqueous electrolyte solution contains an aromatic compound in an amount of 2 to 15% by mass with respect to a total mass of the electrolyte solution, the separator 3 has a MD direction and a TD direction, a heat shrinkage at 150° C. in the TD direction of 30% or less, a thickness of 5 to 20 μm, and an air permeability of 500 seconds/100 ml or less. Because of this, a non-aqueous secondary battery can be obtained, which is excellent in safety and high rate characteristics and is operated stably even at a high temperature. Furthermore, by allowing the non-aqueous secondary battery of the present invention to be contained in electronic equipment, the reliability of the electronic equipment can be enhanced. Furthermore, a prismatic or laminate-shaped non-aqueous secondary battery is pressed in its direction to be contained in electronic equipment, whereby the safety of the electronic equipment can be enhanced.

### TECHNICAL FIELD

The present invention relates to a non-aqueous secondary battery excellent in safety, and electronic equipment containing the same.

### BACKGROUND ART

There tends to be an increasing demand for non-aqueous secondary batteries such as a lithium ion secondary battery due to its large capacity, high voltage, high energy density, and a high output. A further increase in a capacity and in a charging voltage of the non-aqueous secondary battery also have been studied, and a further increase in a discharge capacity by increasing a charging amount of the battery is expected.

In the case of increasing the capacity of a non-aqueous secondary battery, the heat generation quantity of the battery is increased during overcharging, and the battery is likely to exhibit thermal runaway, which causes a problem of decrease in safety of the battery. As means for solving this problem, it is effective that an aromatic compound is contained in an electrolyte solution, as disclosed in JP 5(1993)-36439 A, JP 7(1995)-302614 A, JP 9(1997)-50822 A, JP 10(1998)-275632 A, and the like.

However, in the case where an aromatic compound is contained in an electrolyte solution, a coating suppressing the reaction with respect to the electrolyte solution is formed on the surface of an active material of a positive or negative electrode. Therefore, although the safety is enhanced, the high rate characteristics of a battery are decreased, whereby battery characteristics such as a discharge capacity are decreased compared with a battery using an electrolyte solution containing no aromatic compound. Particularly, in the case where an aromatic compound is contained in an electrolyte solution in an amount of 2% by mass or more with respect to the total mass of the electrolyte solution so as to enhance the safety during overcharging to a predetermined degree or more, the above-mentioned battery characteristics sometimes are decreased remarkably.

### DISCLOSURE OF INVENTION

In one or more embodiments, the present invention relates to a non-aqueous secondary battery including a positive electrode, a negative electrode, a separator, and a non-aqueous electrolyte solution, wherein the positive electrode and the negative electrode are layered via the separator to form an electrode layered body, the non-aqueous electrolyte solution contains an aromatic compound in an amount of 2 to 15% by mass with respect to a total mass of the electrolyte solution, the separator has a MD direction and a TD direction, and a heat shrinkage at 150° C. in the TD direction of 30% or less, and the separator has a thickness of 5 to 20 μm, and an air permeability of 500 seconds/100 ml or less.

Furthermore, in one or more embodiments, the present invention provides electronic equipment containing the above-mentioned non-aqueous secondary battery.

Furthermore, in one or more embodiments, the present invention relates to electronic equipment containing a non-aqueous secondary battery, wherein the non-aqueous secondary battery includes a positive electrode, a negative electrode, a separator, and a non-aqueous electrolyte solution, the non-aqueous secondary battery is formed in a prismatic or laminate shape, and the non-aqueous secondary battery is pressed in its thickness direction to provide electronic equipment.

### BRIEF DESCRIPTION OF DRAWINGS

FIG. 1 is a plan view schematically showing an example of a non-aqueous secondary battery according to the present invention.

FIG. 2 is a vertical cross-sectional view taken along a line A-A of the non-aqueous secondary battery shown in FIG. 1.

### BEST MODE FOR CARRYING OUT THE INVENTION

The inventors have performed various studies regarding the configuration of a non-aqueous secondary battery containing an aromatic compound in an electrolyte solution in order to solve the above-mentioned problem. Consequently, we found that the safety and high rate characteristics of the battery are both achieved in the case of overcharging, by using a separator with a thickness of 5 to 20 μm and an air permeability of 500 seconds/100 ml or less.

Non-aqueous secondary batteries, each including an electrode layered body in which positive and negative electrodes are layered via a separator and a non-aqueous electrolyte solution, were produced by using various separators satisfying the above-mentioned configuration, and the storage characteristics of the batteries were evaluated at a high temperature. Consequently, it was clarified that some batteries generate heat due to an internal short circuit in the case of being retained in a high-temperature environment. More specifically, it was found that there may be the following possibility: when a battery is left in an environment at about 150° C., the positive and negative electrodes directly come into contact with each other at end portions of the electrodes due to the shrink of the separator, whereby the temperature of the battery is increased remarkably. This is because the separator is likely to thermally shrink even when being interposed between the positive and negative electrodes, in the case where the thickness of the separator is thin (20 μm or less). It was found that the characteristics of the separator to be used are limited more strictly than before in the battery with the above-mentioned configuration. In particular, under a situation in which a battery is contained in electronic equipment, the heat generated inside the battery during charging is unlikely to be released out of the battery, which increases the temperature of the battery unexpectedly. Thus, the inventors have found that the safety of a battery in an environment at about 150° C. is important, thereby achieving the present invention.

Furthermore, the inventors also have studied a more effective attachment form of a battery in electronic equipment using a non-aqueous secondary battery, in addition to an additive of an electrolyte solution.

Hereinafter, the embodiment of the present invention will be described. One embodiment of the present invention is a non-aqueous secondary battery including a positive electrode, a negative electrode, a separator, and a non-aqueous electrolyte solution. The positive and negative electrodes are layered via the separator to constitute an electrode layered body, and the non-aqueous electrolyte contains an aromatic compound in an amount of 2 to 15% by mass with respect to the total mass of the electrolyte solution. The separator has a MD direction and a TD direction, and a heat shrinkage of 30% or less at 150° C. in the TD direction. Furthermore, the separator has a thickness of 5 to 20 μm and an air permeability of 500 seconds/100 ml or less.

Because of the above configuration, a non-aqueous secondary battery excellent in safety, high rate characteristics, and storage at a high temperature can be provided.

As the aromatic compound to be contained in the above-mentioned non-aqueous electrolyte solution, compounds, capable of forming a coating on the surface of an active material of a positive or negative electrode in a battery, can be used. Specific examples of the compounds include those in which an alkyl group is bonded to an aromatic ring, such as cyclohexylbenzene, isopropylbenzene, t-butylbenzene, octylbenzene, toluene, xylene, and the like; those in which a halogen group is bonded to an aromatic ring, such as fluorobenzene, difluorobenzene, trifluorobenzene, chlorobenzene, and the like; those in which an alkoxy group is bonded to an aromatic ring, such as anisole, fluoroanisole, dimethoxybenzene, diethoxybenzene, and the like; aromatic carboxylic acid esters such as a phthalate ester (e.g., dibutyl phthalate, di-2-ethylhexylphthalate, etc.) and a benzoic acid ester; carbonic acid esters having a phenyl group such as methyl phenyl carbonate, butylphenyl carbonate, diphenyl carbonate, and the like; phenyl propionate; biphenyl; and the like. Furthermore, as the aromatic compound, those which are dissolved in an electrolyte solution are desirable. Since an ionic compound such as LiB(C₆H₅)₄ has poor stability, nonionic compounds are desirable. Among them, compounds in which an alkyl group is bonded to an aromatic ring are preferable. In particular, cyclohexylbenzene is used preferably.

Furthermore, the above-mentioned aromatic compound may be used alone. When two or more kinds thereof are used, an excellent effect is exhibited. In particular, by using a compound in which an alkyl group is bonded to an aromatic ring together with a compound in which a halogen group is bonded to an aromatic ring, a particularly preferable result is obtained in terms of enhancement of safety.

There is no particular limit to a method for allowing an aromatic compound to be contained in a non-aqueous electrolyte solution. However, a method for previously adding an aromatic compound to an electrolyte solution before assembling a battery is generally used. As the content of the aromatic compound in the non-aqueous electrolyte solution is larger, the safety of the battery is enhanced. However, in the case where the adding amount of the aromatic compound exceeds 15% by mass with respect to the total mass of the non-aqueous electrolyte solution containing the aromatic compound, high rate characteristics are decreased remarkably even when a separator with a thickness of 20 μm or less and an air permeability of 500 seconds/100 ml or less is used. Furthermore, in the case where the content of the aromatic compound is less than 2% by mass, there is almost no problem in a decrease in high rate characteristics, so that the characteristics of the separator are not particularly limited. Thus, it is effective that the separator with a thickness of 20 μm or less and an air permeability of 500 seconds/100 ml or less is used with respect to a battery in which an aromatic compound is contained in an amount of 2 to 15% by mass in a non-aqueous electrolyte solution.

A more preferable range of the content of the aromatic compound is 4% by mass or more in terms of safety and 10% by mass or less in terms of high rate characteristics. In the case where a mixture of two or more kinds of aromatic compounds is used, the total amount thereof may be in the above range. Particularly, in the case where a compound in which an alkyl group is bonded to an aromatic ring is used together with a compound in which a halogen group is bonded to an aromatic ring, the compound in which an alkyl group is bonded to an aromatic ring is desirably 0.5% by mass or more, more desirably 2% by mass or more, and desirably 8% by mass or less, more desirably 5% by mass or less. On the other hand, the compound in which a halogen group is bonded to an aromatic group is desirably 1% by mass or more, more preferably 2% by mass or more, and desirably 12% by mass or less and more desirably 4% by mass or less.

Examples of an organic solvent used in the above-mentioned non-aqueous electrolyte solution include chain esters such as dimethyl carbonate, diethyl carbonate, methyl ethyl carbonate, methyl propionate, and the like; chain triester phosphate such as trimethyl phosphate; 1,2-dimethoxyethane; 1,3-dioxolane; tetrahydrofuran; 2-methyl-tetrahydrofuran; diethylether; and the like. In addition, amine- or imide-based organic solvent, sulfur-based organic solvents such as sulfolane, and the like also can be used. Among them, it is desirable to use chain carbonate such as dimethyl carbonate, diethyl carbonate, methyl ethyl carbonate, and the like. The amount of these organic solvents is desirably less than 90% by volume, and more desirably 80% by volume or less with respect to the total volume of an electrolyte solution. Furthermore, the amount of the organic solvents is desirably 40% by volume or more, more desirable 50% by volume or more, and most desirably 60% by volume or more in terms of high rate characteristics.

Furthermore, as the other component of the electrolyte solution, it is desirable to mix an ester having a high dielectric constant (30 or more). Examples of the ester having a high dielectric constant include sulfur-based esters such as ethylene glycol sulfite, as well as ethylene carbonate, propylene carbonate, butylene carbonate, y-butyrolactone, and the like. Furthermore, the esters having a high dielectric constant preferably have a cyclic configuration. In particular, cyclic carbonate such as ethylene carbonate is preferable. The amount of the above-mentioned ester with a high dielectric constant is desirably less than 80% by volume, more desirably 50% by volume or less, and most desirably 35% by volume or less with respect to the entire volume of the electrolyte solution. Furthermore, the amount of the ester is desirably 1% by volume or more, more desirably 10% by volume or more, and most desirably 25% by volume or more.

In order to further enhance the effect of the present invention, it is preferable that a solvent having a —SO₂— bond, in particular, a solvent having a —O—SO₂— bond is dissolved in the above electrolyte solution. Examples of the solvent having a —O—SO₂— bond include 1,3-propane sultone, methyl ethyl sulfonate, diethyl sulfate, and the like. The content thereof is preferably 0.5% by mass or more, more preferably 1% by mass or more, and preferably 10% by mass or less, more preferably 5% by mass or less with respect to the total mass of the electrolyte solution.

The above-mentioned non-aqueous electrolyte may contain a polymer component such as polyethylene oxide and poly(methylmethacrylate), and may be used as a gel electrolyte.

As the electrolyte of the electrolyte solution, LiClO₄, LiPF₆, LiBF₄, LiAsF₆, LiSbF₆, LiCF₃SO₃, LiC₄F₉SO₃, LiCF₃CO₂, Li₂C₂F₄(SO₃)₂, LiN(Rf₂)(RfSO₂), LiN(RfOSO₂)(RfOSO₂), LiC(RfSO₂)₃, LiCₙF₂ₙ₊₁SO₃ (n≧2), LiN(RfOSO₂)₂ (where, Rf is a fluoroalkyl group), a polymer imide lithium salt, and the like are used alone or in combination of two or more kinds. When these electrolytes are taken in a coating on the surface of an electrode, the coating can be provided with satisfactory ion conductivity, and its effect is enhanced particularly in the case of using LiPF₆, which is desirable. There is no particular limit to the concentration of the electrolyte in the electrolyte solution. However, the concentration is set desirably to be 1 mol/l or more, and more desirably to be 1.2 mol/l or more, since the safety is enhanced. Furthermore, the concentration is desirably less than 1.7 mol/l, and more desirably less than 1.5 mol/l, since high rate characteristics are enhanced.

As the above-mentioned separator, those which have a MD direction and a TD direction, a heat shrinkage of 30% or less at 150° C. in the TD direction, a thickness of 5 to 20 μm, and an air permeability of 500 seconds/100 ml or less are used. In order to obtain satisfactory high rate characteristics in a non-aqueous secondary battery using a non-aqueous electrolyte solution containing an aromatic compound in a range of 2 to 15% by mass, it is necessary that the thickness of the separator is 20 μm or less, and the air permeability thereof is 500 seconds/100 ml or less. Furthermore, in order to prevent an internal short circuit in a high-temperature state of a battery, it is necessary that the separator has a MD direction and a TD direction, and a heat shrinkage of 30% or less at 150° C. in the TD direction. Herein, the MD direction refers to the take-up direction of film resin in the course of production of a separator, and the TD direction refers to the direction orthogonal to the MD direction, as described in JP 2000-172420 A. According to the present invention, a separator having such directivity is used. The heat shrinkage in the TD direction was obtained by interposing a separator (vertical size: 45 mm, horizontal size: 60 mm) between two smooth glass plates with a thickness of 5 mm, a vertical size of 50 mm, and a horizontal size of 80 mm (mass: 47 g), allowing the separator to stand still horizontally in a homoithermal chamber kept at 150° C., keeping the separator in this state for 2 hours, returning the temperature to room temperature (20° C.), and comparing the length of a shrunk portion in the TD direction with the length of the separator before shrink.

The thickness of the separator needs to be 20 μm or less so as to obtain high rate characteristics and to increase a capacity, and a thinner separator is preferable. However, in order to keep satisfactory insulation and decrease the heat shrinkage, it is necessary to set the thickness to be 5 μm or more. It is more preferable to set the thickness to be 10 μm or more. Furthermore, it is necessary to set the air permeability of the separator to be 500 seconds/100 ml or less in order to enhance high rate characteristics. The air permeability is set more preferably to be 400 seconds/100 ml or less, and most preferably to be 350 seconds/100 ml or less. When the air permeability is too small, an internal short circuit is likely to occur. Therefore, the air permeability is set preferably to be 50 seconds/100 ml or more, more preferably to be 100 seconds/100 ml or more, and most preferably 200 seconds/100 ml or more.

The tensile strength of the separator is set desirably to be 6.8×10⁷ N/m² or more, and more desirably to be 9.8×10⁷ N/m² or more as tensile strength in the MD direction. The upper limit value of the tensile strength in the MD direction generally is set depending upon the material, and about 108 N/m² is an upper limit value in the case of a polyethylene separator.

Furthermore, it is desirable that the tensile strength in the TD direction is smaller than that in the MD direction. A ratio S2/S 1 (ratio of the tensile strength S2 in the TD direction with respect to the tensile strength S1 in the MD direction) is desirably 0.95 or less, more desirably 0.9 or less and desirably 0.5 or more, more desirably 0.7 or more. In this range, the thermal shrink at 150° C. in the TD direction can be suppressed while puncture strength described below is maintained.

The puncture strength of the separator is desirably 2.9 N or more, and more desirably 3.9 N or more. As a puncture strength is higher, a battery is unlikely to be short-circuited. Generally, the upper limit value is set depending upon the material, and about 10 N is an upper limit value in the case of a polyethylene separator. The puncture strength of the separator was measured by reading a maximum load from a time when a pin with a diameter of 1 mm having a tip end in a semicircular shape with a radius of 0.5 mm is pierced into a separator at 2 mm/s to a time when the pin passes through the separator.

As the heat shrinkage of the separator is smaller, an internal short circuit is unlikely to occur. Therefore, it is desirable to use a separator with a smaller heat shrinkage. It is more desirable to use a separator with a heat shrinkage of 10% or less, and a separator with a heat shrinkage of 5% or less is preferably used. An example of such a separator includes microporous polyethylene film “F20DHI” (Trade Name) produced by Tonen Kagaku K.K., and the like.

Furthermore, in order to suppress the thermal shrink of the separator, the separator may be previously heat-treated at about 120° C.

Furthermore, as a positive active material used for a positive electrode, a lithium complex oxide such as LiCoO₂, LiMn₂O₄, LiNiO₂ and the like, which allows a open-circuit voltage during charging to exhibit 4 V or more based on Li, preferably is used. In these active materials, a part of Co, Ni, and Mn may be replaced with another element, respectively. In the case where Ge, Ti, Ta, Nb, and Yb are contained as substitute elements, the content thereof is desirably 0.001 atomic % or more, more desirably 0.003 atomic % or more, and desirably 3 atomic % or less, more desirably 1 atomic % or less.

In the case where the specific surface of a positive active material is large, although high rate characteristics are satisfactory, safety is degraded. According to the present invention, even an active material with a large specific surface to some degree can be used safely, and an active material with a specific surface of about 1 m²/g or less can be used without any problem. The lower limit value of the specific surface preferably is 0.2 m²/g or more.

Furthermore, it is further desirable that a lithium salt is allowed to be present previously in a positive active material for the following reason. By allowing an aromatic compound and a lithium salt to be present together, a positive electrode is provided with ion conductivity, the uniform reactivity of an electrode is enhanced, and safety is further enhanced. Examples of the lithium salt include inorganic lithium salts such as LiBF₄, LiClO₄, and the like; organic lithium salts such as C₄F₉SO₃Li, C₈F₁₇SO₃Li, (C₂F₅SO₂)₂NLi, (CF₃SO₂)(C₄F₉SO₂)NLi, (CF₃SO₂)₃CLi, C₆H₅SO₃Li, C₁₇H₃₅COOLi, and the like. An organic lithium salt is desirable in terms of thermal stability and safety, and a fluorine-containing organic lithium salt is desirable in the case of considering ion dissociation.

A conductive aid and a binder such as polyvinylidene fluoride are appropriately added to the above-mentioned positive active material to form a positive mixture. A molding is prepared using a current collecting material (e.g., metal foil) as a core, using the positive mixture, to obtain a positive electrode. As the conductive aid of the positive electrode, a carbon material is desirable. The using amount of the carbon material is desirably 5% by mass of less and more preferably 3% by mass or less with respect to the total mass of the positive material. Furthermore, the using amount is desirably 1.5% by mass or more, in order to ensure conductivity.

On the other hand, as a negative active material used for a negative electrode, those which can subject lithium ions to doping/de-doping reversibly may be used. For example, carbon materials such as natural graphite, pyrolytic carbons, cokes, glass carbons, sintered organic polymer compounds, Mesocarbon Microbeads, carbon fibers, activated carbon, and the like can be used. Furthermore, an alloy of Si, Sn, In, or the like, or compounds of oxides or nitrides capable of being charged/discharged at a low potential close to that of Li may be used. Furthermore, in the same way as in the positive electrode, in order to form a stable protective coating on the surface of an electrode to suppress the reaction of an electrolyte with an electrode, it is desirable to allow a lithium salt to be previously present in a negative active material.

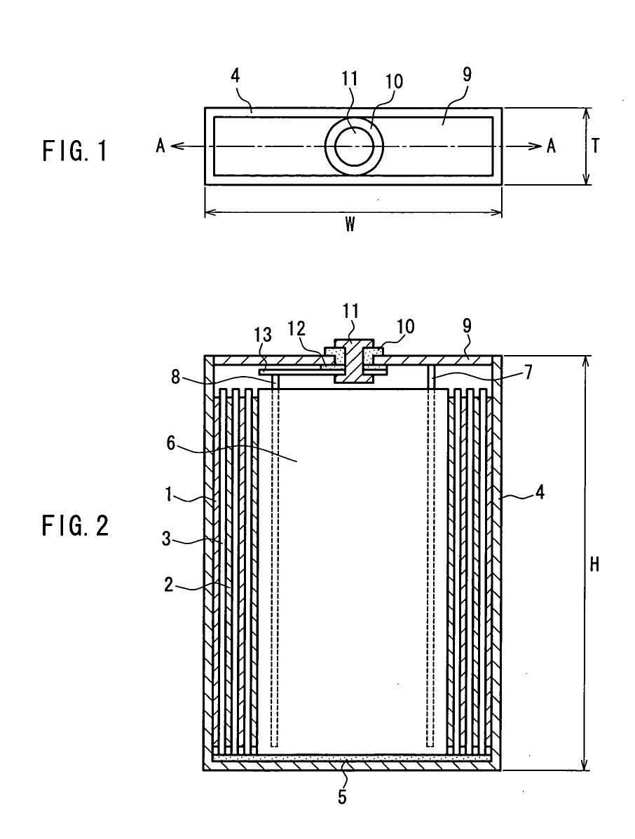

Next, the embodiment of the present invention will be described with reference to the drawings. FIG. 1 is a plan view schematically showing an example of a non-aqueous secondary battery according to the present invention. FIG. 2 is a vertical cross-sectional view taken along a line A-A of the non-aqueous secondary battery shown in FIG. 1. FIGS. 1 and 2 show a prismatic battery, where T, W, and H represent a thickness, a width, and a height, respectively. This also applies to a layered battery.

In FIG. 2, a positive electrode 1 and a negative electrode 2 are wound in a spiral shape via a separator 3, pressed to as to be flat to form an electrode layered body 6 with a flat winding configuration, and accommodated in a battery case 4 with an electrolyte solution. In FIG. 2, for simplicity, a metal foil as a current collector, an electrolyte solution, and the like used for producing the positive electrode 1 and the negative electrode 2 are not shown.

The battery case 4 is formed of an aluminum alloy or the like, and is to be an outer shell of a battery. The battery case 4 also functions as a positive terminal. Furthermore, an insulator 5 made of a polytetrafluoroethylene sheet is placed on a bottom of the battery case 4. A positive lead 7 and a negative lead 8 connected to each one end of the positive electrode 1 and the negative electrode 2 are drawn from the electrode layered body 6 with a flat winding configuration comprised of the positive electrode 1, the negative electrode 2, and the separator 3. Furthermore, a terminal 11 made of stainless steel is attached to a cover plate 9 made of an aluminum alloy sealing an opening of the battery case 4 via an insulating packing 10 made of polypropylene, and a lead plate 13 made of stainless steel is attached to the terminal 11 via an insulator 12. Furthermore, the cover plate 9 is inserted into the opening of the battery case 4, and connecting portions of the cover plate 9 and the battery case 4 are welded, whereby the opening of the battery case 4 is sealed, and the inside of the battery is enclosed.

In the above-mentioned embodiment, the positive lead 7 is directly welded to the cover plate 9, whereby the battery case 4 and the cover plate 9 function as a positive terminal. The negative lead 8 is welded to the lead plate 13, and the negative lead 8 is brought into conduction with the terminal 11 via the lead plate 13, whereby the terminal 11 functions as a negative terminal. However, depending upon the material of the battery case 4, the positive and negative electrodes may be reversed.

Next, an embodiment of electronic equipment of the present invention will be described. The electronic equipment of the present embodiment contains the above-mentioned non-aqueous secondary battery. Because of this, even in the case where a charge control mechanism is not operated successfully, heat generation of the battery is small, so that the electronic equipment can be prevented from being broken and losing reliability. More specifically, in a conventional battery with its capacity increased by using a thin separator, the battery itself generates heat due to an internal short circuit caused by an increase in the temperature of the battery, and the temperature of the battery is further increased. Because of this, the electronic equipment containing such a battery is likely to be damaged by the heat generation of the battery. Particularly, such an effect is remarkable in the electronic equipment having a large charging current of 0.6 A or more. However, in the non-aqueous secondary battery of the present invention, an internal short circuit at a high temperature is suppressed from occurring, so that the above-mentioned problem is unlikely to arise, and the reliability of the electronic equipment can be enhanced.

Furthermore, regarding the attachment form of the non-aqueous secondary battery to the electronic equipment, a prismatic or laminate-shaped non-aqueous secondary battery is contained in electronic equipment under the condition of being pressed in its thickness direction, whereby safety can be enhanced. Usually, in the case where a battery is overcharged due to the failure of the equipment and the like, the battery expands, an electrode body in the battery is deformed, a current flows concentratedly, and the battery is likely to generate heat locally. In the attachment form of the present invention, the battery is unlikely to expand, the electrodes are suppressed from being deformed, and the concentration of a current is alleviated, whereby the heat generation of the battery can be suppressed. It is desirable that the battery is pressed with a surface smaller than the side surface of the battery in the electronic equipment. The area to be pressed is desirably 95% or less, more desirably 80% or less, and most desirably 50% or less of the side surface of the battery. Furthermore, it is more effective that the battery is pressed mainly in the vicinity of the central portion on the side surface of the battery, and it is desirable that the battery is pressed at 5 g or more in an initial state. The battery is pressed more desirably at 100 g or more, and most desirably at 500 g or more. When the pressure is too large, there is a possibility that an electrode body is damaged, so that 5 kg or less is desirable. The vicinity of the central portion on the side surface of the battery refers to a center side of a small rectangle, in the case where the small rectangle with a width of W/2 and a height of H/2 (W is a width of the side surface of the battery, and H is a height thereof is placed in the central portion on the side surface so that two diagonals are matched with each other.

Furthermore, in the electronic equipment containing a non-aqueous secondary battery in the above embodiment, it is further desirable to use an electrolyte solution containing an aromatic compound as a non-aqueous electrolyte solution of the non-aqueous secondary battery. It is further desirable to use a separator with a thickness of 5 to 20 μm and an air permeability of 500 seconds/100 ml or less. Furthermore, it is most desirable that the non-aqueous secondary battery of the present invention is contained in electronic equipment in the above embodiment. The reason for this is as follows: in the case where a battery is overcharged in electronic equipment, an aromatic compound in a non-aqueous electrolyte solution is reacted to allow a gentle short circuit to be likely to occur, which decreases a substantial overcharging current, and decreases the highest battery surface temperature during overcharging. When a separator is thin, the distance between electrodes is small, which allows a gentle short circuit to be likely to occur, which is desirable.

There is no particular limit to the electronic equipment capable of containing the above non-aqueous secondary battery. Examples of the electronic equipment include various electronic equipment such as portable electronic equipment (e.g., a mobile telephone, a notebook personal computer, a PDA, small medical equipment, and the like), business equipment with a battery backup function, medical equipment, and the like.

Next, the present invention will be described in detail by way of examples. The present invention is not limited only by the following examples.

### EXAMPLE 1

A mixed solvent of ethylene carbonate and methyl ethyl carbonate (volume ratio 1:2) was prepared. LiPF₆ was dissolved in the mixed solvent in a concentration of 1.2 mol/l. Then, 4% by mass of cyclohexylbenzene, 3% by mass of fluorobenzene, and 2% by mass of 1,3-propanesultone, which were aromatic compounds, were added to the resultant mixed solvent with respect to the total mass of electrolytes, whereby a non-aqueous electrolyte solution was prepared.

Separately, LiCu_{0.995}° Ge_{0.005}O₂ with a specific surface of 0.5 m²/g as a positive active material, carbon as a conductive aid, and (C₂F₅SO₂)₂NLi as a lithium salt were mixed in a mass ratio of 97.9:2:0.1. This mixture was mixed with a solution in which polyvinylidene fluoride (binder) was dissolved in N-methylpyrrolidone to produce a positive mixture slurry. The positive mixture slurry was passed through a filter to remove large particles. Thereafter, the resultant positive mixture slurry was applied uniformly to both surfaces of a positive current collector made of a band-shaped aluminum foil with a thickness of 15 μm, followed by drying. Then, the positive current collector was molded by compression with a roller press. The positive current collector was cut, and leads were welded thereto, whereby a band-shaped positive electrode was produced. A portion of the positive electrode that was not opposed to a negative electrode coating area was not coated with the positive mixture. The positive current collector used herein contained 1% by mass of Fe and 0.15% by mass of Si. The purity of aluminum was 98% by mass or more, and the tensile strength thereof was 185 N/mm².

Next, a negative electrode was produced as follows. Graphite with d₀₀₂=0.335 nm and an average particle size of 15 μm and (C₂F₅SO₂)₂NLi were used as negative active materials. A solution in which polyvinylidene fluoride (binder) was dissolved in N-methylpyrrolidone was mixed with the negative active material to produce a negative mixture slurry. Herein, the ratio of (C₂F₅SO₂)₂NLi was set to be 0.1% by mass with respect to the mass of the graphite. The negative mixture slurry was passed through a filter to remove large particles. Thereafter, the negative mixture slurry was applied uniformly to both surfaces of a negative current collector made of a band-shaped copper foil with a thickness of 10 μm, followed by drying. Thereafter, the negative current collector was molded by compression with a roller press. The negative current collector was cut and leads were welded thereto, whereby a band-shaped negative electrode was produced. A portion of the negative electrode coated with the negative mixture was set to be larger by 1 mm in a width direction than the portion of the positive electrode coated with the positive mixture, and was set to be larger by about 5 mm in a longitudinal direction. The other portion of the negative electrode that was not opposed to the positive electrode coating area during winding was not coated with a negative mixture. This is because the safety of the battery also is enhanced by setting the size of the portion coated with the positive mixture to be equal to or smaller than that of the portion coated with the negative mixture. Herein, the density of the negative mixture portion of the negative electrode was 1.55 g/cm³.

The band-shaped positive electrode and the band-shaped negative electrode were layered via a microporous polyethylene film “F20DHI” (air permeability: 344 seconds/100 ml, puncture strength: 4.5 N, pore ratio: 39.4%, tensile strength in a MD direction: 1.3×10⁸ N/m², tensile strength in a TD direction: 1.1×10⁸ N/m², heat shrinkage at 150° C. in the TD direction: 5%) produced by Tonen Kagaku K.K. with a thickness of 20 μm, and wound so as to be flat to obtain an electrode layered body. Thereafter, the circumference of the electrode layered body was attached with a tape. The electrode layered body was inserted to an aluminum alloy can for a battery with a thickness of 4 mm, a width of 30 mm, and a height of 48 mm, leads were welded thereto, and laser welding of a cover plate for sealing was performed.

Next, the prepared electrolyte solution was injected to a battery case through an injection port. The injection port was sealed after the electrolyte solution sufficiently permeated to a separator and the like. Then, previous charging and aging were performed, whereby a prismatic non-aqueous secondary battery with a configuration as shown in FIG. 1 was produced. The capacity of the non-aqueous secondary battery of the present example was 600 mAh.

### EXAMPLE 2

A non-aqueous secondary battery was produced in the same way as in Example 1, except that fluorobenzene was not added an electrolyte solution.

### COMPARATIVE EXAMPLE 1

A non-aqueous secondary battery was produced in the same way as in Example 2, except that cyclohexylbenzene was not added to an electrolyte solution.

### COMPARATIVE EXAMPLE 2

A non-aqueous secondary battery was produced in the same way as in Example 2, except that a microporous polyethylene film (air permeability: 240 seconds/100 ml, tensile strength in a MD direction: 1.4×10⁸ N/m², tensile strength in a TD direction: 1.3×10⁸ N/m²) with a thickness of 20 μm and a heat shrinkage at 150° C. of 34% was used as a separator.

### COMPARATIVE EXAMPLE 3

A non-aqueous secondary battery was produced in the same way as in Example 2, except that a microporous polyethylene film (tensile strength in a MD direction: 1.3×10⁸ N/m², tensile strength in a TD direction: 9.3×10⁷ N/m², heat shrinkage at 150° C. in the TD direction: 10%) with a thickness of 20 μm and an air permeability of 590 seconds/100 ml was used as a separator.

### COMPARATIVE EXAMPLE 4

A non-aqueous secondary battery was produced in the same way as in Example 2, except that a microporous polyethylene film (air permeability: 650 seconds/100 ml, tensile strength in a MD direction: 1.1×10⁸ N/m², tensile strength in a TD direction: 1.0×10⁸ N/m², heat shrinkage at 150° C. in the TD direction: 20%) with a thickness of 25 μm was used as a separator.

The above-mentioned batteries of Examples 1-2 and Comparative Examples 1-4 were charged at a constant current at room temperature (20° C.) until a battery voltage reached 4.2 V at a current value of 0.12 A (0.2° C.), and charged at a constant voltage of 4.2 V. Charging was completed after 7 hours from the commencement of charging. Then, the batteries were discharged to 3 V at 0.12 A (0.2 C). The potential of the positive electrode during charging was about 4.3 V. Furthermore, the batteries were charged under the above charge condition. Thereafter, the batteries were discharged to 3 V at 1.2 A (2 C), and a discharge capacity was measured. Furthermore, high rate characteristics were evaluated based on the ratio of the discharge capacity at 2 C with respect to the discharge capacity at 0.2 C. Table 1 shows the result. In Table 1, high rate characteristics (%) were shown by (Discharge capacity at 2 C/Discharge capacity at 0.2 C)×100.

Furthermore, separate from the batteries used in the above measurement, the respective 5 batteries of Examples 1-2 and Comparative Examples 1-4 were charged to 4.25 V at 0.2 C, and then, charged at a constant voltage of 4.25 V. Charging was completed after 7 hours from the commencement of charging. After the completion of charging, the batteries were placed in an explosion-proof homoiothermal chamber, and the temperature thereof was increased to 150° C. at a temperature increase speed of 5° C./min. from room temperature (20° C.). A test of holding the batteries at 150° C. for 60 minutes was performed, the surface temperature of the batteries during the test was measured, and the highest achieved temperature was measured with respect to the surface temperature of each battery. The highest value among the highest achieved temperatures of the respective batteries was shown as a highest battery temperature in Table 1.

TABLE 1

| | High rate characteristics | Highest battery |
|---|---|---|
| | (%) | temperature (° C.) |
| Example 1 | 97 | 160 |
| Example 2 | 97 | 165 |
| Comparative Example 1 | 97 | 173 |
| Comparative Example 2 | 97 | 180 or more |
| Comparative Example 3 | 92 | 162 |
| Comparative Example 4 | 89 | 161 |

In the batteries of Examples 1 and 2, by using an electrolyte solution containing an aromatic compound in a range of 2 to 15% by mass as a non-aqueous electrolyte solution, and a separator having a MD direction and a TD direction, a heat shrinkage at 150° C. in the TD direction of 30% or less, a thickness of 5 to 20 μm, and an air permeability of 500 seconds/100 ml of less, high rate characteristics were excellent. In addition, an internal short-circuit of a battery in the case where the battery was exposed to high temperature was suppressed, and an increase in temperature of the battery itself was suppressed. In particular, the battery of Example 1 using both a compound in which an alkyl group was bonded to an aromatic ring and a compound in which a halogen group was bonded to an aromatic ring exhibited excellent characteristics.

On the other hand, in the battery of Comparative Example 1 in which an aromatic compound was not contained in an electrolyte solution and the battery of Comparative Example 2 in which a separator with a heat shrinkage at 150° C. in the TD direction was larger than 30%, the highest battery temperature in a heating test at 150° C. was higher than that of Example 2, resulting in a decrease in stability at high temperature. Particularly, in the battery of Comparative Example 2 with a separator having a large heat shrinkage, the temperature of the battery was increased exceeding 180° C. that was a measurement limit. Thus, the battery of Comparative Example 2 was not suitable for use at high temperature. Furthermore, in the battery of Comparative Example 3 using a separator having an air permeability larger than 500 seconds/100 ml and the battery of Comparative Example 4 using a separator having a thickness larger than 20 μm, high rate characteristics were decreased largely.

Next, the batteries of Example 1 and Comparative Example 1 were contained respectively in mobile telephones “C451H” (Trade Name) produced by Hitachi Ltd. as power supplies, and the following test was performed. Assuming the case where a protection circuit and a charging circuit are broken, after stopping the functions of the protection circuit, PTC, and voltage control circuit, charging was performed up to 12 V at a current value of 1 A. Thereafter, charging was performed at a constant voltage of 12 V (Test A). Consequently, in the mobile telephone using the battery of Example 1 according to the present invention, no deformation, breakage, and the like in an outer appearance were found in the mobile telephone even after the completion of the test.

Next, the battery of Example 1 produced in the same way was attached to the above mobile telephone, and a plastic plate with a thickness of 1 mm, a horizontal size of 15 mm, and a vertical size of 24 mm was placed at a position corresponding to the center of the central portion on a side surface of the battery via a battery cover on a reverse side of the mobile telephone. Then, a pressure of 500 g was applied to this position in a thickness direction, whereby overcharging was performed in the same way as in the above (Test B). Consequently, in Test B, the battery was unlikely to generate heat, compared with the case of Test A, and the highest battery temperature during overcharging was decreased by 18° C.

On the other hand, Tests A and B were performed in the same way as the above using the battery of Comparative Example 1. The mobile telephone was broken and did not function normally in both the tests.

The above-mentioned test was performed after stopping the functions of the protection circuit, PTC, and voltage control circuit. It should be appreciated that the reliability of the electronic equipment is further enhanced by adding the respective protection functions.

### INDUSTRIAL APPLICABILITY

As described above, the present invention relates to a non-aqueous secondary battery in which an aromatic compound is contained in an amount of 2 to 15% by mass in a non-aqueous electrolyte solution with respect to the total mass of an electrolyte solution, a separator has a MD direction and a TD direction, the heat shrinkage at 150° C. in the TD direction is 30% or less, the thickness of the separator is 5 to 20 μm, and the air permeability thereof is 500 seconds/100 ml or less. Thus, a non-aqueous secondary battery can be obtained, which is excellent in safety and high rate characteristics and is operated stably even a high temperature. Furthermore, by allowing the non-aqueous secondary battery of the present invention to be contained in electronic equipment, the reliability of the electronic equipment can be enhanced. Furthermore, a prismatic or laminate-shaped non-aqueous secondary battery is contained in electronic equipment under the condition of being pressed in a thickness direction, whereby safety can be enhanced.

1. A non-aqueous secondary battery comprising a positive electrode, a negative electrode, a separator, and a non-aqueous electrolyte solution,
wherein the positive electrode and the negative electrode are layered via the separator to form an electrode layered body,
the non-aqueous electrolyte solution comprises an aromatic compound in an amount of 2 to 15% by mass with respect to a total mass of the electrolyte solution,
the separator has a MD direction and a TD direction, and a heat shrinkage at 150° C. in the TD direction of 30% or less, and
the separator has a thickness of 5 to 20 μm, and an air permeability of 500 seconds/100 ml or less.

2. The non-aqueous secondary battery according to claim 1, wherein the aromatic compound comprises a compound in which an alkyl group is bonded to an aromatic ring and a compound in which a halogen group is bonded to an aromatic ring.

3. The non-aqueous secondary battery according to claim 2, wherein the non-aqueous electrolyte solution comprises the compound in which an alkyl group is bonded to the aromatic ring in an amount of 0.5 to 8% by mass with respect to a total mass of the electrolyte solution, and comprises the compound in which a halogen group is bonded to the aromatic ring in an amount of 1 to 12% by mass with respect to a total mass of the electrolyte solution.

4. The non-aqueous secondary battery according to claim 1, wherein the non-aqueous electrolyte comprises chain carbonate in an amount of 40% by volume to less than 90% by volume with respect to a total volume of the electrolyte solution, and comprises cyclic carbonate in an amount of 1% by volume to less than 80% by volume with respect to a total volume of the electrolyte solution.

5. The non-aqueous secondary battery according to claim 1, wherein the non-aqueous electrolyte solution comprises a solvent having a —SO₂— bond.

6. The non-aqueous secondary battery according to claim 1, wherein a tensile strength of the separator in the MD direction is 6.8×10⁷ N/m² or more.

7. The non-aqueous secondary battery according to claim 1, wherein a ratio S2/S1 of a tensile strength S2 of the separator in the TD direction with respect to a tensile strength S1 of the separator in the MD direction is 0.5 to 0.95.

8. The non-aqueous secondary battery according to claim 1, wherein a puncture strength of the separator is 2.9 N or more.

9. The non-aqueous secondary battery according to claim 1, wherein the separator is heat-treated at a temperature of about 120° C.

10. The non-aqueous secondary battery according to claim 1, wherein the positive electrode comprises a lithium complex oxide as a positive active material.

11. The non-aqueous secondary battery according to claim 10, wherein a specific surface of the positive active material is 1 m²/g or less.

12. The non-aqueous secondary battery according to claim 1, wherein the negative electrode comprises, as a negative active material, a material capable of subjecting lithium ions to doping and de-doping reversibly.

13. The non-aqueous secondary battery according to claim 1, wherein at least one selected from the positive electrode and the negative electrode previously comprises a lithium salt.

14. Electronic equipment comprising a non-aqueous secondary battery,
wherein the non-aqueous secondary battery comprises a positive electrode, a negative electrode, a separator, and a non-aqueous electrolyte solution,
the positive electrode and the negative electrode are layered via the separator to form an electrode layered body,
the non-aqueous electrolyte solution comprises an aromatic compound in an amount of 2 to 15% by mass with respect to a total mass of the electrolyte solution,
the separator has a MD direction and a TD direction, and a heat shrinkage at 150° C. in the TD direction of 30% or less, and
the separator has a thickness of 5 to 20 μm, and an air permeability of 500 seconds/100 ml or less.

15. The electronic equipment according to claim 14, wherein the aromatic compound comprises a compound in which an alkyl group is bonded to an aromatic ring and a compound in which a halogen group is bonded to an aromatic ring, and the non-aqueous electrolyte solution comprises the compound in which an alkyl group is bonded to the aromatic ring in an amount of 0.5 to 8% by mass with respect to a total mass of the electrolyte solution and the compound in which a halogen group is bonded to the aromatic ring in an amount of 1 to 12% by mass with respect to a total mass of the electrolyte solution.

16. The electronic equipment comprising a non-aqueous secondary battery,
wherein the non-aqueous secondary battery comprises a positive electrode, a negative electrode, a separator, and a non-aqueous electrolyte solution,
the non-aqueous secondary battery is formed in a prismatic or laminate shape, and
the non-aqueous secondary battery is pressed in its thickness direction.

17. The electronic equipment according to claim 16, wherein the non-aqueous electrolyte comprises an aromatic compound.

18. The electronic equipment according to claim 16, wherein the separator has a thickness of 5 to 20 μm and an air permeability of 500 seconds/100 ml or less.

19. The electronic equipment according to claim 16, wherein the positive electrode and the negative electrode are layered via the separator to form an electrode layered body,
the non-aqueous electrolyte solution comprises an aromatic compound in an amount of 2 to 15% by mass with respect to a total mass of the electrolyte solution,
the separator has a MD direction and a TD direction, and a heat shrinkage at 150° C. in the TD direction of 30% or less, and
the separator has a thickness of 5 to 20 μm, and an air permeability of 500 seconds/100 ml or less.

20. The electronic equipment according to claim 19, wherein the aromatic compound comprises a compound in which an alkyl group is bonded to an aromatic ring and a compound in which a halogen group is bonded to an aromatic ring, and the non-aqueous electrolyte solution comprises the compound in which an alkyl group is bonded to the aromatic ring in an amount of 0.5 to 8% by mass with respect to a total mass of the electrolyte solution and the compound in which a halogen group is bonded to the aromatic ring in an amount of 1 to 12% by mass with respect to a total mass of the electrolyte solution.
